(19) United States
(12) Patent Application Publication
(10) Pub. No.: US 2023/0096200 A1
(43) Pub. Date: Mar. 30, 2023

(54) Online Platform Providing the Opportunity to Trade Items or Experiences

(71) Applicant: THE NOBO INC., San Francisco, CA (US)

(72) Inventor: Noelle BONNER, San Francisco, CA (US)

(73) Assignee: THE NOBO INC., San Francisco, CA (US)

(21) Appl. No.: 17/800,104

(22) PCT Filed: Feb. 17, 2021
(86) PCT No.: PCT/US2021/018351

§ 371 Date: Aug. 16, 2022

Related U.S. Application Data
(60) Provisional application No. 62/982,828, filed on Feb. 28, 2020.

(51) Int. Cl. G06Q 30/0601; G06Q 10/083

(52) U.S. Cl. CPC G06Q 30/0611; G06Q 30/0613; G06Q 10/083

(57) ABSTRACT

An online platform and method of facilitating the trading, including purchasing or bartering, of products, goods or experiences, such as a stay in a hotel or tickets to a concert etc. or other luxury items using a server is described. The system and method employs a database for storing information on a previously owned luxury item offered by a first user and an electronic network to send a description of the item for trade from the database only if the item is deemed to be a luxury item and has been authenticated.

### CROSS-REFERENCE TO RELATED APPLICATIONS

This application claims benefit of U.S. Provisional Patent Application No. 62/982,828 which was filed on Feb. 28, 2020 and titled “Online Platform Providing the Opportunity to Trade, Sell or Buy Items or Experiences”. The entire content of this application is incorporated herein by reference.

### TECHNICAL FIELD

The present invention relates to methods and systems for trading products, experiences or other items over a network; and provides the opportunity for trading, including purchasing or bartering, between users remote from each other.

### BACKGROUND

Online commerce has grown over time and is now considered essential to the modern economy. The Internet allows people to communicate over large distances. As such, the Internet allows many people to buy, and sell products with one another who would normally never meet absent the Internet. However, major online retailers such as AMAZON only list products for sale and do not typically sell previously used items. Instead, large online retail sellers simply sell mass produced products. Other sites, such as EBAY and CRAIGSLIST, do allow for sales between individuals of used items. However, such sites typically only enable people to sell to each other. The sites display pictures of goods for sale and provide pricing information. Often the sites will accept payment and arrange for shipping of the goods to the buyer. These sites do provide for sellers to review buyers and vice versa but do not independently verify the products that are sold. As a result, many products are counterfeit and a buyer cannot be assured of the quality of the item being purchased.

There have been some proposed solutions to this situation. For example, the company “The RealReal” provides consignment services wherein a user chooses what to consign (example categories and brands the company accepts include: handbags, fine jewelry, Chanel, Rolex, etc.). Next, the user ships items directly to the company with a free, prepaid label. Then the company's “team of 100+ luxury brand authenticators, horologists, gemologists and home and art curators carefully evaluate every item” and prices and sells each item. However, The RealReal does not provide bartering support.

U.S. Patent Application Publication No. 2016/0350830, incorporated herein by reference, discloses exchanging, trading or bartering goods through transactions facilitated by a network site. As disclosed in paragraphs 29-44, a user A proposes a transaction by posting, on the network site, an offer of a product or good user A desires to buy, sell or trade. Posting involves providing information such as a title, description, photos, video and an estimated value or desired price. User A may offer a product or good that user A can provide and lists a product or good that user A wishes to receive. A user B can see the listing and accepts the offer if user B is able to provide the product or good that user A wishes to receive. Counteroffers can be made and the network site deducts a commission. The product or good is sent to an agent which evaluates the product or good. The agent can stand continuously ready to facilitate the trade, barter or exchange. However, this system still inherently delays the trade while an item is evaluated. U.S. Patent Application Publication No. 2017/0316478, also incorporated herein by reference, discloses a system for trading items over a network but is not seen to provide robust quality control.

A trading model for items of value such as luxury goods, or experiences does not exist in today's market. For luxury consumers who presently wish to sell or buy luxury goods, experiences or other items, the options are generally to find a consignment store, employ a personal shopper, or use an online platform for consignment. The currently available online solutions for buying/selling have many disadvantages, including lack of a personalized experience, excessive inventory, and lack of authentication in the peer-to-peer model. Additionally, the cost of using a consignment store can be prohibitive and may easily be 50% of the resale price. Also, most consignment stores are currently limited in that only customers who walk in the store can buy the items for sale, which often forces consumers to attempt to trade through unsophisticated mediums. Currently, there is simply no easy way to have items quickly and efficiently evaluated or certified by an independent expert prior to trade. With the above in mind, there exists a need to provide users the opportunity to trade through a sophisticated, “white glove” platform with authenticated luxury items.

### SUMMARY OF THE INVENTION

The present invention is directed to a system and method for facilitating trading, including exchanging or bartering of products, goods, experiences or other items using an online platform including a server with a processor. An experience could be a stay in a hotel, tickets to a concert, stay in a furnished residence, travel package, etc. Initially, a first and second user will access a company website to set up user accounts. The users are informed that the website is used to buy and sell or trade products, experiences or other items and that the items are authenticated by the company or a facilitating agent and then listed for sale. In one preferred embodiment, the method includes sending a previously owned luxury item to the company and having a facilitating agent authenticate the item. Authentication also known as “white glove” means that the item is physically inspected by the company for authenticity, quality, and value. Preferably, the company takes pictures of the item and stores the pictures and other information about the item, on a non-transitory computer-readable medium, in a database. The method also includes sending, through an electronic network, a description of the item from the database and receiving, from the electronic network, an inquiry for the item including an offer for a reciprocal item within a predetermined value bandwidth of the item from a second user. The bandwidth could vary from 1% to 30% or even wider, but 10% is a preferred value. A trade of the item for the reciprocal item is completed by the processor, if both users agree. The platform processor then takes a trade transaction fee. Alternatively, instead of being offered for trade, the item may simply be offered for sale. In a sale type transaction, authentication may only be required for high value items over a certain limit. Preferably, the limit is $3,500 but the limit may be adjusted, particularly even higher.

Another preferred embodiment of the invention is a feature by which consignment items of a certain value, as well as trade items of a certain value, are authenticated by the company. In offering an opportunity to trade, the present invention allows users to conserve the value of their luxury items because, in trading, the value of their items is not lost in traditional consignment fees that can be as high as 50% of the resale price. As a result, the opportunity to conserve value through trade will bring new luxury buyers, who may remain anonymous, to the retail luxury market, and to the platform of the invention, when buyers look to acquire “new for them” authenticated luxury items.

Additional objects, features and advantages of the present invention will become more readily apparent from the following detailed description of preferred embodiments when taken in conjunction with the drawings wherein like reference numerals refer to corresponding parts in the several views.

### BRIEF DESCRIPTION OF THE DRAWINGS

The disclosure may be more completely understood in consideration of the following description of various illustrative embodiments in connection with the accompanying drawings.

FIG. 1 is a schematic view of an online trading platform connected to users through the Internet according to a preferred embodiment of the invention.

FIG. 2 is a flow chart showing the steps for a user to place an item on consignment for sale using the online trading platform of FIG. 1.

FIG. 3 is a flow chart showing the steps for a user to list an item for trade using the online trading platform of FIG. 1.

FIG. 4 is a flow chart showing the steps for a user to complete a trade of one item for another using the online trading platform of FIG. 1.

FIG. 5 is a screen shot of a home page of the online trading platform of FIG. 1.

FIGS. 6-9 are screen shots of trading pages for the online trading platform of FIG. 1.

FIGS. 10 and 11 are screen shots of consignment pages for the online trading platform of FIG. 1.

FIG. 12 is a screen shot of a product search page for the online trading platform of FIG. 1.

FIG. 13 is a screen shot of a product shipping page for the online trading platform of FIG. 1.

FIG. 14 is a screen shot of an account information page for the online trading platform of FIG. 1.

FIG. 14 is a screen shot of a page for saving links to favorite items for the online trading platform of FIG. 1.

FIG. 15 is a screen shot of a favorites page for the online trading platform of FIG. 1.

FIG. 16 is a screen shot of a trade page for the online trading platform of FIG. 1.

FIG. 17 is a screen shot of a page listing the status of pending trades for the online trading platform of FIG. 1.

FIGS. 18A-C show a flow chart of steps taken to place an item for sale or trade with an authentication step according to a second preferred embodiment of the invention.

FIG. 19 is a flow chart for sales transactions according to the third preferred embodiment of the invention.

FIG. 20 is a flow chart for trade transactions adding authentication steps.

FIGS. 21A-C show a flow chart for sale or trade of items with some items being particularly valuable and requiring authentication.

FIG. 22A and 22B show a flow chart for selling items with some items being particularly valuable and requiring authentication.

### DETAILED DESCRIPTION OF THE PREFERRED EMBODIMENTS

The following detailed description should be read with reference to the drawings in which similar elements in different drawings are numbered the same. The detailed description and the drawings, which are not necessarily to scale, depict illustrative embodiments and are not intended to limit the scope of the disclosure. The illustrative embodiments depicted are intended only as exemplary. Selected features of any illustrative embodiment may be incorporated into an additional embodiment unless clearly stated to the contrary. While the disclosure is amenable to various modifications and alternative forms, specifics thereof have been shown by way of example in the drawings and will be described in detail. It should be understood, however, that the intention is not to limit aspects of the disclosure to the particular illustrative embodiments described. On the contrary, the intention is to cover all modifications, equivalents, and alternatives falling within the spirit and scope of the disclosure.

As used in this specification and the appended claims, the singular forms “a”, “an” and “the” include plural forms unless the content clearly dictates otherwise. As used in this specification and the appended claims, the term “or” is generally employed in its sense including “and/or” unless the content clearly dictates otherwise.

In addition, any specific numerical value listed includes a margin of error of +/−5%. The term “approximately” increases these various margins to 10% and 10°.

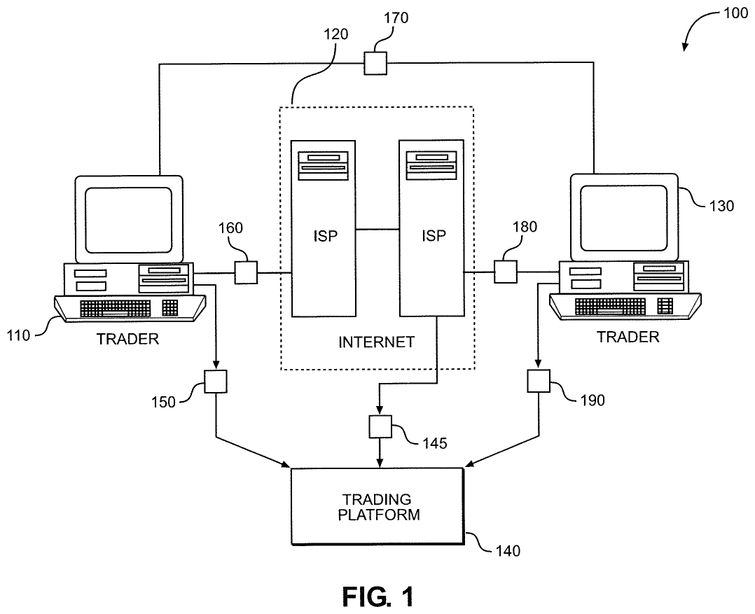

FIG. 1 shows an overall communications and trading system 100 that connects a first trader with a computer 110 via the Internet 120 to a second trader with another computer 130. A trading platform 140, which is an online platform preferably constituted by a server having a processor, is also connected to the Internet 120 through a line of communication 145. Separate lines of communication from the first trader may be provided to trading platform 140, directly at 150, to the Internet 120 at 160 and to the second trader's computer 130 at 170. Likewise, lines of communication are provided to the second trader's computer 130 to the Internet 120 at 180 and to trading platform 140 at 190. Online trading platform 140 provides users the opportunity to trade, sell or buy previously owned luxury items.

As illustrated in FIG. 1, first trader's computer 110 is formed of one or more computers and includes an input-output unit for transmitting and receiving digital information to or from the Internet 120. First trader's computer 110 typically has a monitor, a central processing unit, some type of memory and an input-output unit such as a keyboard. Typically, when in use, first trader's computer 110 would have some type of operating system such as Macintosh, Unix or Windows which would run the basic operations of the computing machine. Additionally, specialized applications such as a web browser would be used to interpret the various protocols of Internet 120 into an understandable interface for a computer user, namely the trader. The computer 110 also could be in the form of a smart phone or a tablet type computing device.

In a similar manner, the second trader's computer 130 may be formed of one or more computers, having one or more monitors, a central processing unit, some type of memory and an input-output device such as a keyboard. Additionally, various applications such as a web server and/or specialized applications that form a website providing information regarding the trader's products, and additional applications designed to process financial transactions and/or provide a database for remembering and storing various bits of information regarding the various other trader's visiting the second trader's website. Further, the traders' computers 110, 130 have the programming to compare inputted data and authorize shipping of goods.

Although in theory the traders' computers 110, 130 could be part of any data network, most preferably the computers are connected to the Internet 120 or an internet service provider (ISP) by a high speed integrated service digital network ISDN, a T-1 line, a T-3 line or any other type of communication system with other computers or ISP's which typically form the Internet 120. Both traders may communicate using the Internet 120. Alternatively, they may contact each other and trading platform 140 by separate communication mechanisms. Such communications could be by telephone, by talking person to person, or any other form of communication.

Initially, a first and second user will access a company website controlled by the processor on trading platform 140 with respective computers 110, 130 to set up user accounts. For example, the website could prompt a new user to set up an account. The user would then enter information required to set up the account such as name, email, phone number and store name. An email is then sent to the user's address to confirm the email address. Once the user has confirmed the email address, the user is considered registered and the website administrators are sent a notice about the new registration. The user is informed that trading platform 140 is used to buy and sell or trade products, experiences or other items and that certain items are authenticated by the company running trading platform 140 before the products are listed for sale. The user finishes setting up the account by entering address and payment information. Alternatively, a prior user is allowed to bypass registration and log into an account.

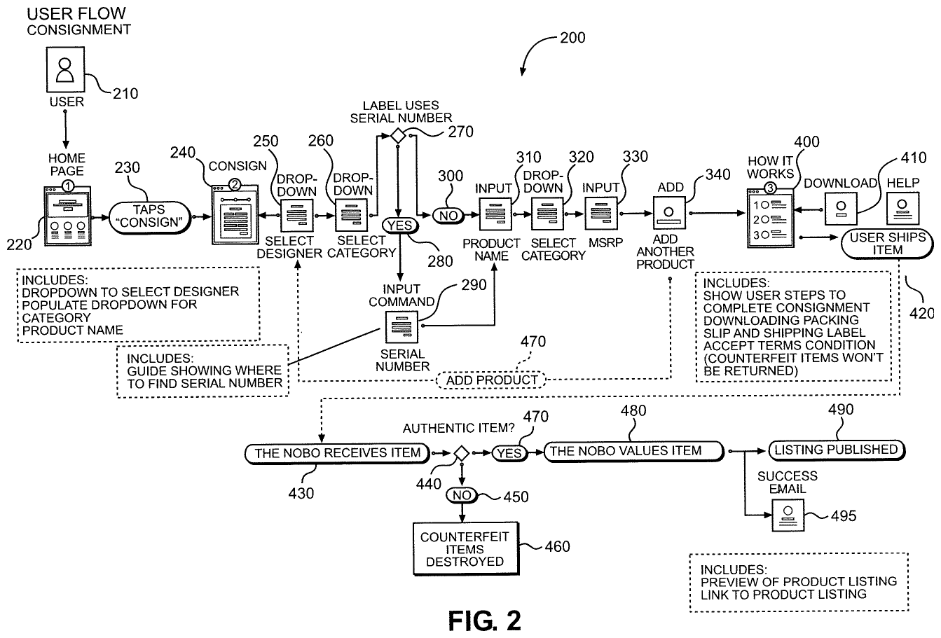

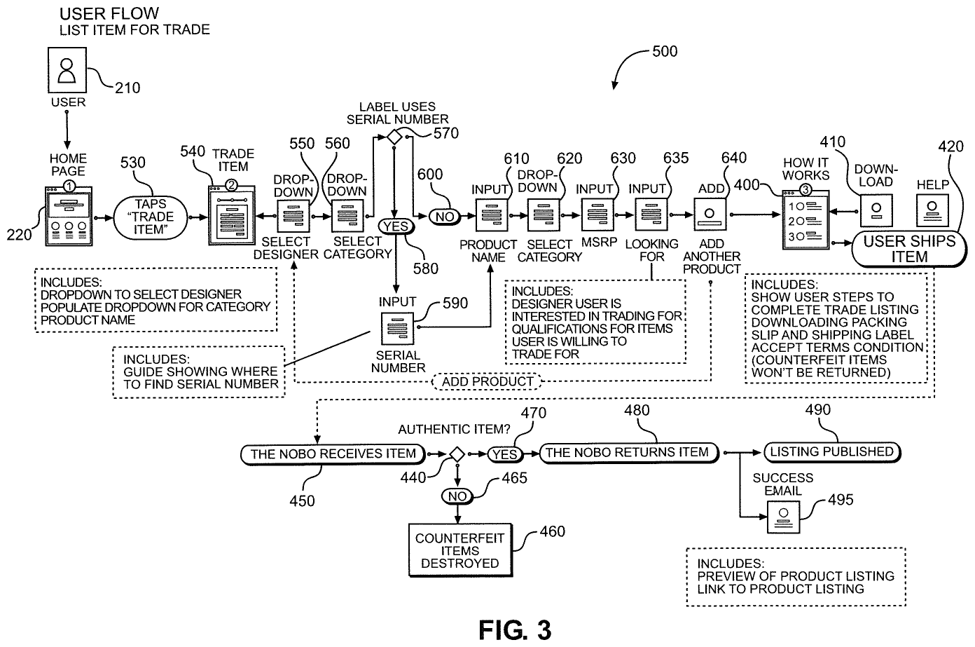

A user can add an item for sale (consignment) or for trade. The operation regarding sale/consignment of items is described below with regard to FIG. 2 and the operation regarding trading of items is described below with regard to FIG. 3. While any product, experience or other item may be traded, e.g., bartered or sold with the online platform described below, the following description mainly sets forth selling and trading products by way of example.

Sales with Authentication

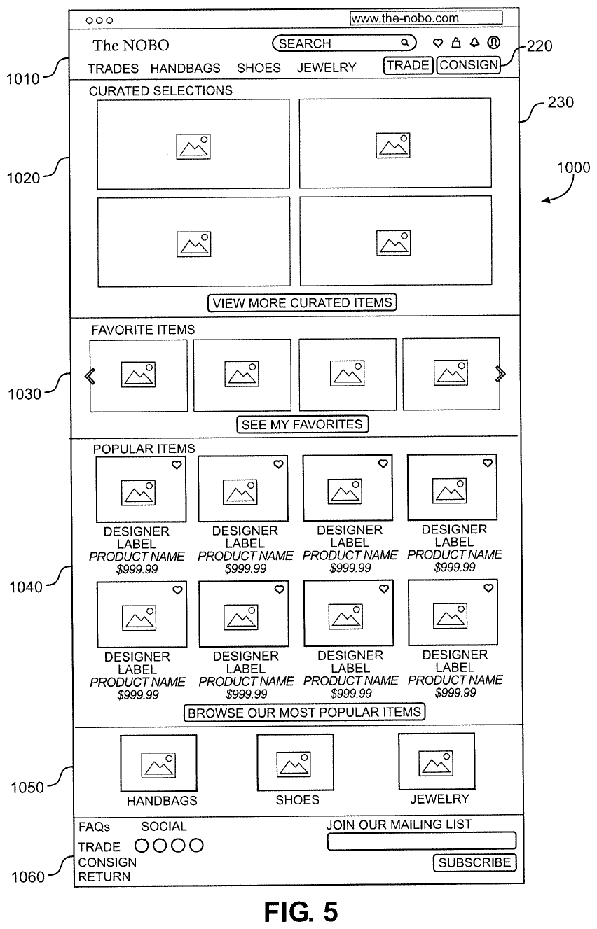

The operation of online platform 140 with regard to a trader placing an item on consignment will now be described with reference to FIG. 2 which shows a flow chart indicating the various steps of the process 200. A user 210, also called a trader, enters information into computer 110 to start a web browser that will open a home page 220 associated with trading platform 140. More details of home page 220 are discussed below with respect to FIG. 5. User 210 then taps or selects a “consign” radio button 230 on home page 220 or otherwise selects an option to sell an item, to display a consignment page 240. While page 240 is called a consignment page, the page could have other names indicating an item for sale from a user's store. On consignment page 240, two dropdown menus are presented. In one dropdown menu, a designer selection menu 250 enables selection of a designer and the other dropdown menu, a category selection menu 260, enables category selection. Again, other methods could be used to select the designer or category. Next, if the item being consigned has a label 270 with a serial number 280, the serial number is determined at step 290. Preferably, instructions are provided on how to find the serial number. The serial number is then read by computer 110 and computer 110 looks up information on the item, such as the item's product name. If the item has no label with a serial number, then at step 300, the process moves directly to step 310, wherein information regarding the item is manually entered by user 210. Two more dropdown menus 320, 330 are provided to enter a category and a manufacturer's suggested retail price.

While dropdown menus are shown, other ways of entering information constituting a description of the item are also employed. Typically, the user will first select a category, brand or designer along with adding a price including, for example, a sales price or a retail price, and attributes such as size, color and others. The user has to upload photos of their product and a video showing the product for administrative review purposes. The user will get an email regarding the new product and another email is sent to the administrators.

Process 200 continues to step 340 wherein user 210 determines if another product should be entered. If so, process 200 proceeds back to step 350 to add a product by proceeding as discussed above. If not, process 200 moves to step 400 wherein process 200 displays to user 210 the steps to complete consignment, including downloading or receiving by email, a packaging slip and shipping label at step 410 and accepting conditions of shipping the item including, for example, that counterfeit items will not be returned. For consignment items with a high value over a certain amount such as $3500 or above, the user ships the item to the organization running online trading platform 140 for authentication at step 420.

Next, the organization running online trading platform 140 receives the item at 430 and determines at step 440 whether or not the item is counterfeit or authentic, preferably by having a facilitating agent determine if the item is counterfeit or authentic. If the item is not authentic, at step 450, the item is destroyed at step 460. If the item is in bad condition the item is rejected and returned to the user. If the item is authentic and in good condition, then the item is valued at 480 and the listing for the item including the description of the item is published at 490. Also, an email is sent at 495 informing user 210 that the item has been determined to be authentic and been assigned a value. The email includes a preview of the item listing.

### List Item for Trade

The operation of online platform 140 with regard to user 210 listing an item for trade will now be described with reference to FIG. 3, which shows a flow chart indicating the various steps of the process 500. User 210 enters information into computer 110 to start a web browser that will open a home page 220 associated with trading platform 140. User 210 then taps or selects a trade radio button or otherwise selects the option to trade an item 530 on home page 220, which changes home page 220 to a trade item page 540. Alternatively, the home page could switch back to the consignment page 240 as the same information will be entered and the description of trade item page 540 is analogous to the description of the consignment page 240. In other words, a single webpage could be used for both trade and consignment functions.

On trade item page 540, two dropdown menus are presented. One dropdown menu, a designer selection menu 550, enables selection of a designer and the other dropdown menu, a category selection menu 560, enables selection of category of items. Alternative methods could be used to select the designer or category. Next, if the item being traded has a label 570 with a serial number 580, the serial number is determined at step 590. Preferably, instructions are provided on how to find the serial number. The serial number is then read by computer 110 and computer 110 looks up information on the item, such as the item's product name. If the item has no label with a serial number, then at step 600 the process moves directly to step 610 wherein information regarding the item is manually entered by user 210. Two more dropdown menus 620, 630 are provided to enter a category and a manufacturer's suggested retail price.

Once again, while dropdown menus are shown, other ways of entering information are also employed. Typically, the user will first select a category, brand or designer along with adding a description price, sales price, retail price, and attributes such as size, color and others. The user has to upload photos of their product and a video showing the product for administrative review purposes. The user gets an email regarding the new product and another email is sent to the administrators.

Process 500 continues to step 640 wherein user 210 determines if another product should be entered. If so, process 500 proceeds back to step 650 to add a product by proceeding as discussed above. If not, process 500 moves to step 400 wherein process 200 explains to user 210 the steps to complete the trade, including downloading or receiving by email a packaging slip and shipping label at step 410, accepting conditions of shipping item including that counterfeit items will not be returned. User 210 then ships the item at step 420. The process continues in the same a manner as described with regard to FIG. 1.

### Items Traded

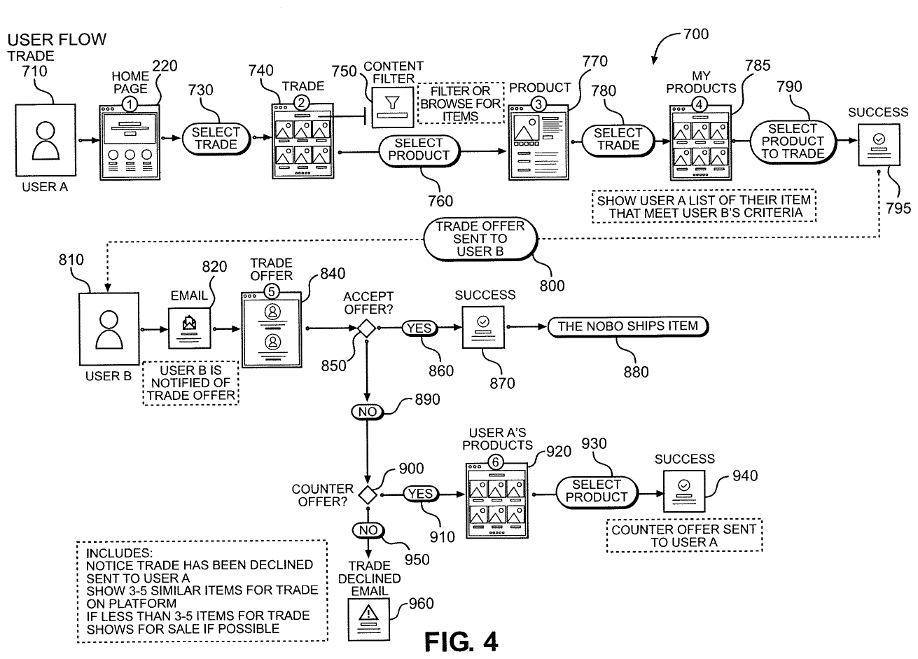

FIG. 4 is a flow chart showing how items are traded. A user (A) 710 activates home page 220 and selects a trade button at 730 bringing up the trade page 740. User A can either select a product directly at 760 or use a content filter 750 to filter for or browse products. A selected product 770 will have a page and, once a trade is selected at 780, a page or selection menu 785 is presented showing eligible products that the owner of the product 770 would trade for that item. User A may trade one of their authenticated items for another user's authenticated item, also referred to as a reciprocal item, that is within a variable price bandwidth of user A's item. Preferably the bandwidth is a 10% price bandwidth of user A's item. The bandwidth could vary from 1% to 20%, or even wider, but 10% is a preferred value. An eligible product is selected at 790 and a message of success 795 is sent to the owner, user (B) 810, who is notified of the trade offer by email 820. Email 820 has a link to open up a trade offer page 840. User B can accept the offer at 850 by sending at 860 message 870 of a successful trade, whereupon the processor of trading platform 140 ships the item at 880. Otherwise, a “no” result at 890 may, at 900, lead to a counteroffer 910 or a trade declined at 960, generating a trade declined email 960. The counteroffer at 910 generates a list of user A's products at 920. If a product is selected at 930, a success email is generated at 940, wherein a counteroffer is sent to user A.

### Screen Shots

FIG. 5 is a screen shot 1000 of home page 220 generated by trading platform 140. Home page 220 has header section 1010 with several radio buttons linking to other pages and includes a “consign” button 230 described above. Home page 220 also has several sections for user 210 to view. There is a section with curated selections 1020, which are suggested items that have been selected by an expert. Next, there is a section of favorite items 1040 that have been selected by user 210 and designated as desirable. Trading platform 140 also presents popular items 1050 which have been traded more often compared to other items. Finally, there is a browsing section 1050 that allows user 210 to browse categories of items such as handbags, shoes or jewelry. Home page 220 also has a footer section 1060 with additional buttons similar to header section 1010. Footer section 1060 allows user 210 to activate several functions of trading platform 140 including accessing a FAQ section or joining a mailing list.

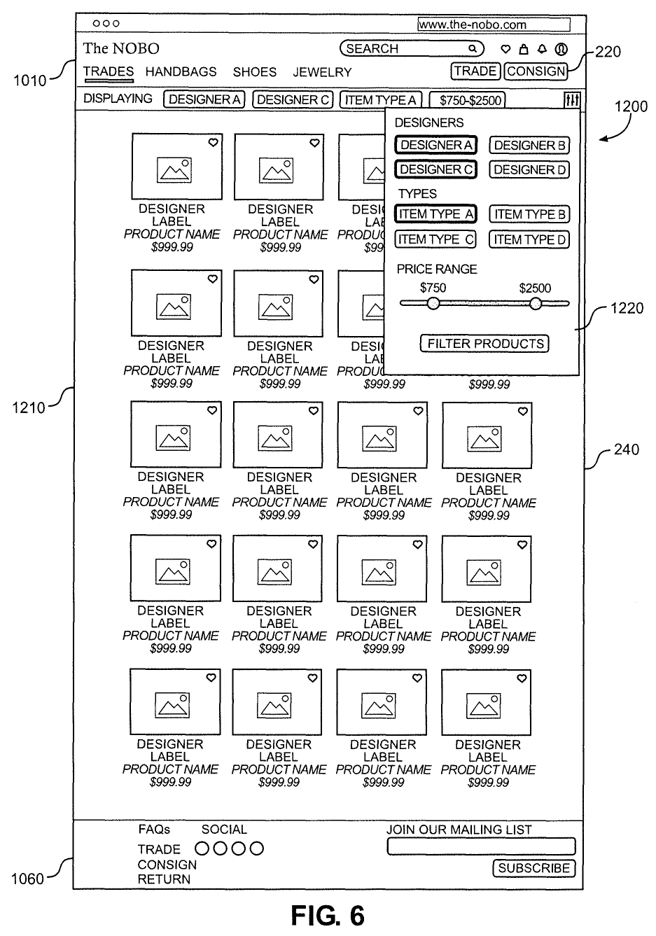

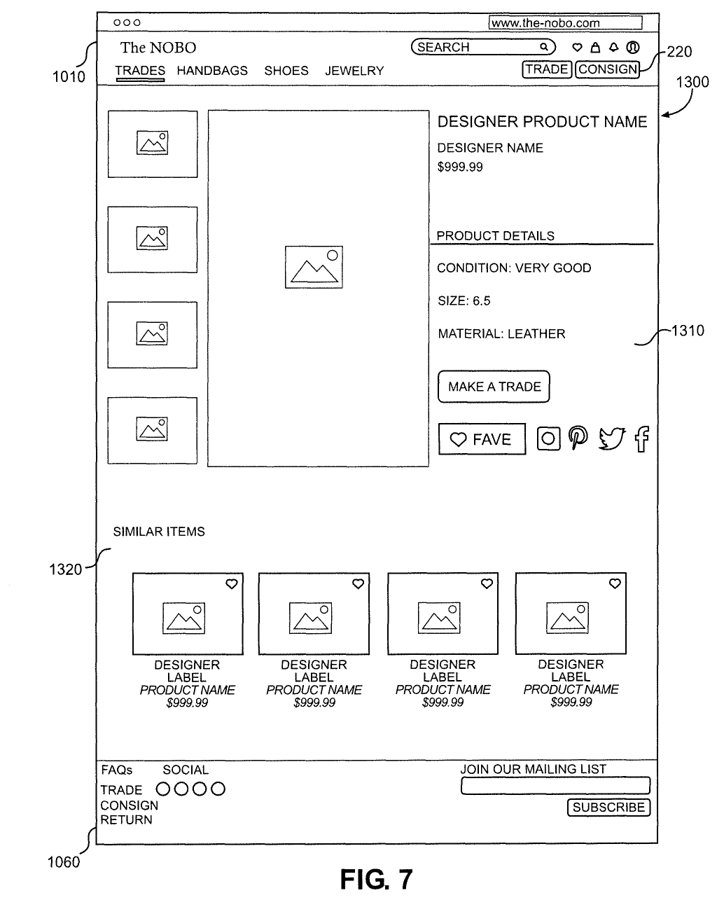

FIG. 6 is a screen shot 1200 of a trade item page 740 described above. Page 740 has a drop down menu 1220 that allows for the selection of designers and types of items. The results are displayed in display area 1210. The results show each item's designer label, product name and value. FIG. 7 shows a screen shot 1300 showing details of a particular product 1310 and includes links allowing product 1310 to be made favorite or to be traded. Additional details of the product, such as condition, size and material are also presented. To aid user 210, trading platform 140 provides a listing 1320 of items similar to the particular product being viewed, which may also be selected.

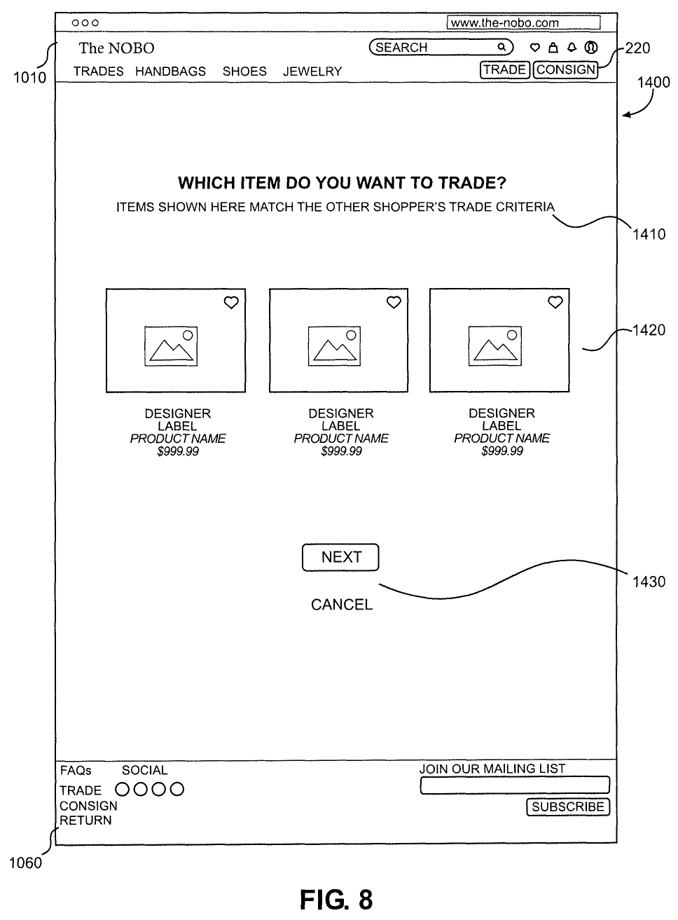

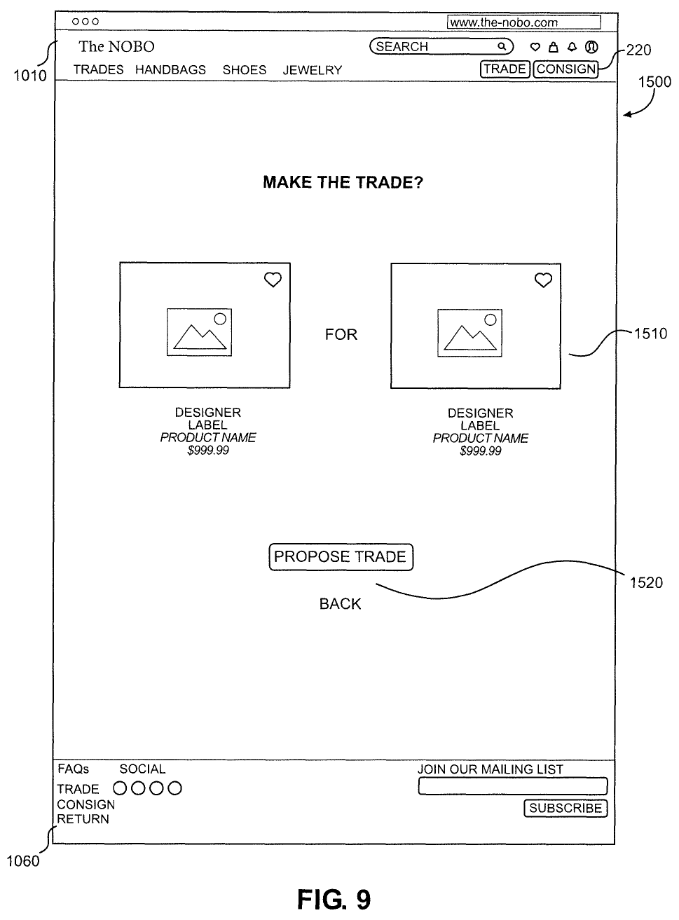

FIG. 8 is a screen shot 1400 presenting a user 210 with options for items that match another shopper's trade criteria 1410. The items are listed with information about the associated products 1420. User 210 selects one of the products 1420 or goes to another page by selecting next, at 1430. Once an item is selected, the actual trade is presented, as shown in screen shot 1500 in FIG. 9 at 1510. User 210 then proposes the trade by selecting button 1520.

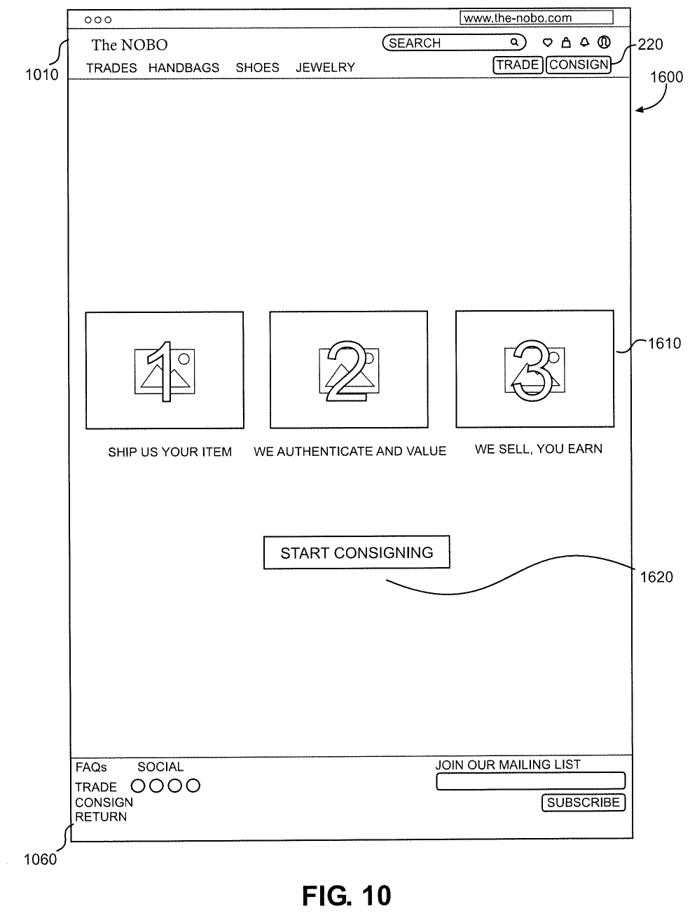

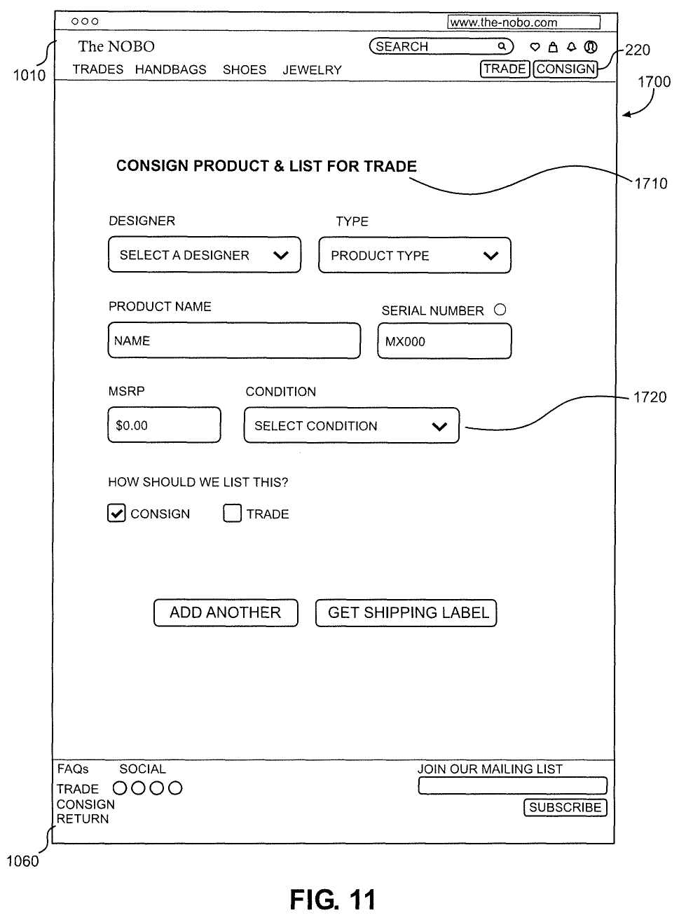

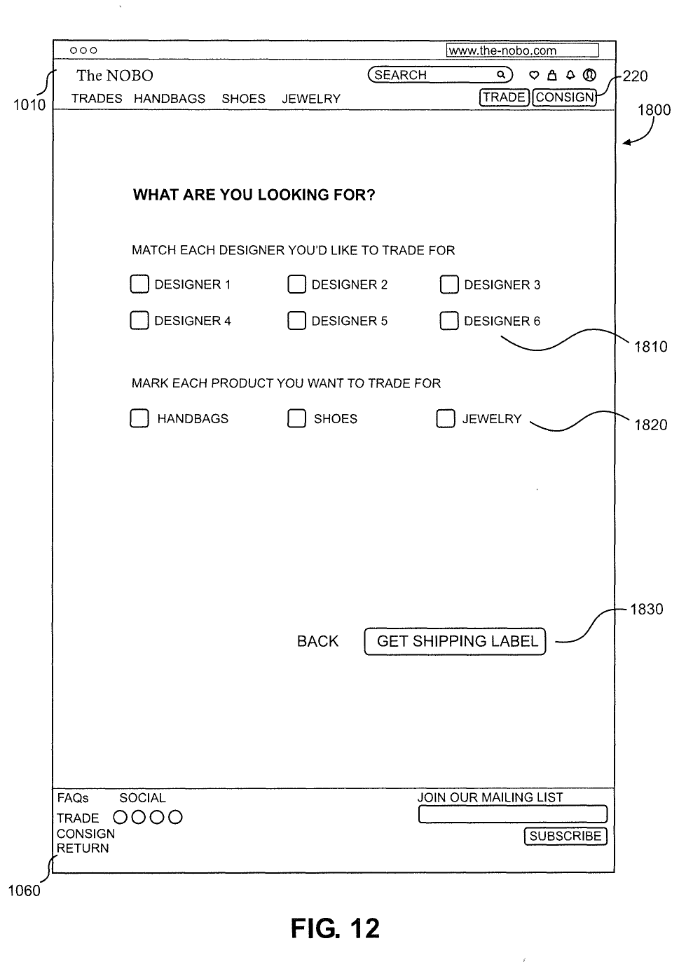

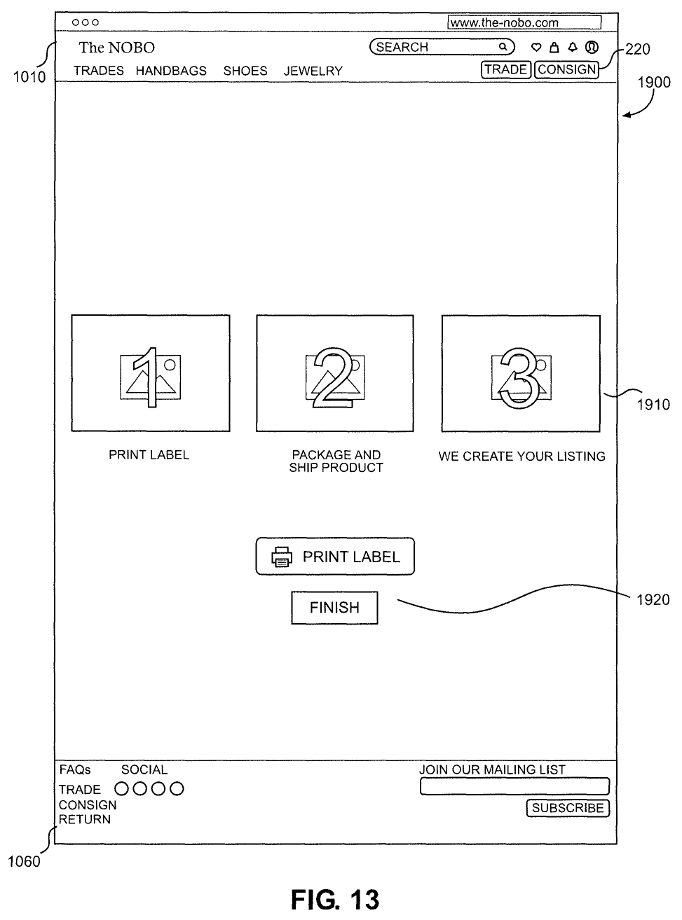

The procedure for consigning an item is shown to user 210 in screen shot 1600 of FIG. 10. Three steps of shipping the item, having online trading platform 140 authenticating the item and then selling the item, are shown at 1610. User 210 starts the process by selecting a button 1620 on screen 1600 which brings the user to screen 1700 shown in FIG. 11. User 210 enters information about the product at 1710 as described above. Next, user 210 can indicate what items are desired for trade on screen 1800 shown in FIG. 12. The designer is selected from a list 1810 of designers and, in a similar manner, the category of the product desired can also be selected from a list 1820. Next, a shipping label is requested using button 1830, bringing user 210 to screen 1900 shown in FIG. 13. The steps of printing a label, packing and shipping a product and creating a listing are explained at 1910 and a label may be printed by selecting button 1920.

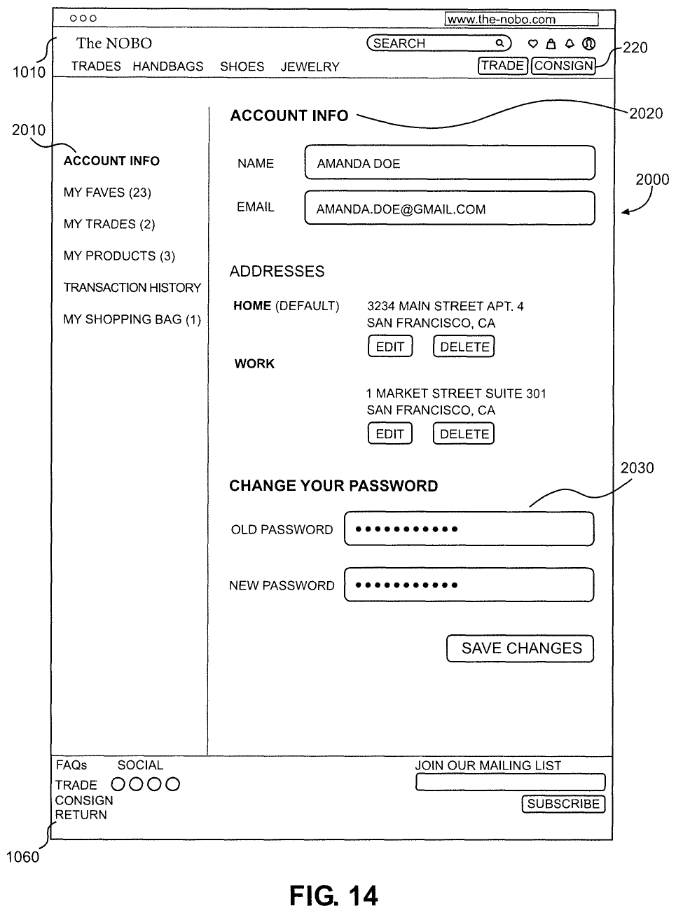

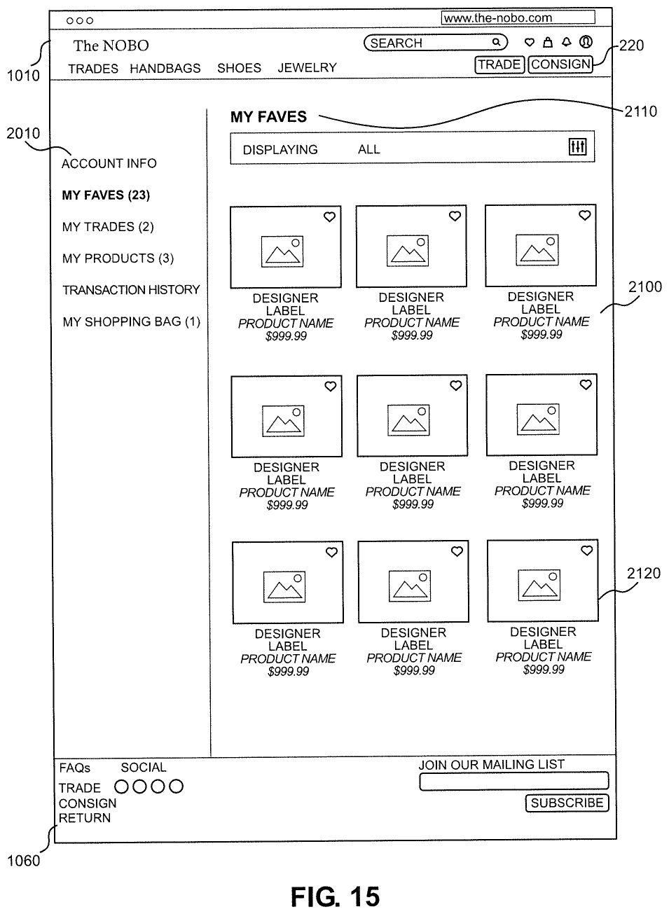

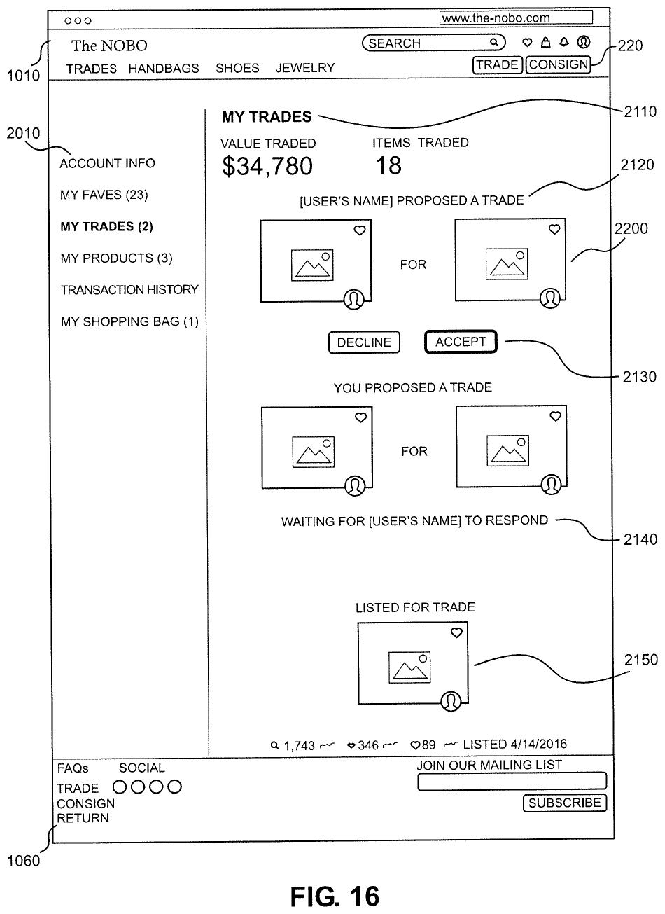

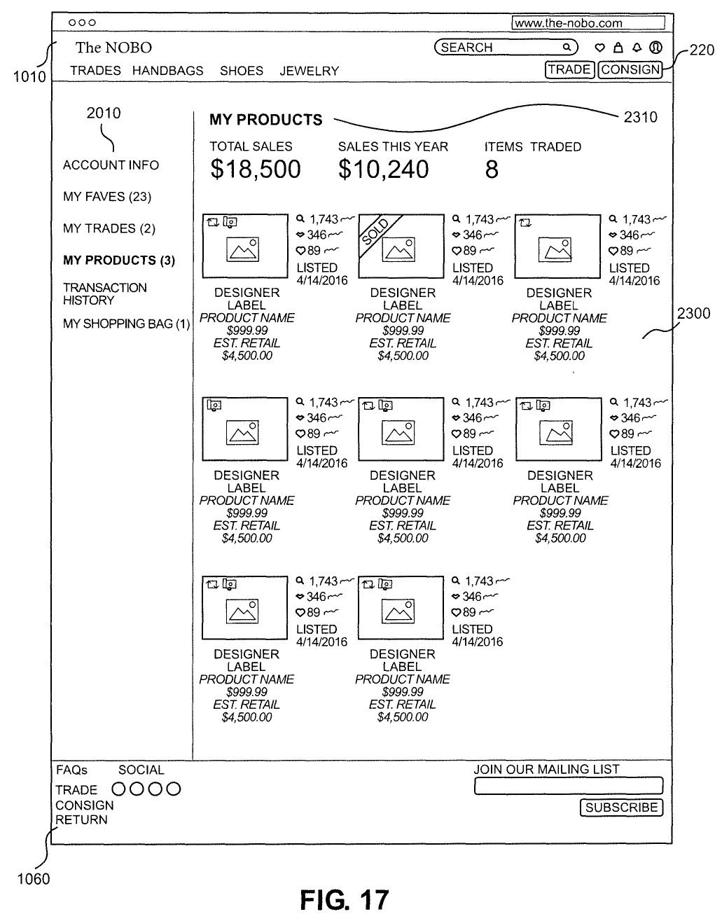

FIG. 14 shows a screen shot 2000 with a menu 2010 allowing access to other screens. Menu 2010 allows access to an account info page 2020 showing the name, email address and physical addresses associated with user 210 and to a feature 2030 allowing for a change of a password. Menu 2010 is also used to access a favorites screen 2100 showing a list 2110 of favorite products and details of the products at 2120, as seen in FIG. 15. Menu 2010 provides access to a trading page 2200 showing trades 2210 of user 210, as shown in FIG. 16. Specifically, proposed trades 2120 which may be accepted or declined at 2130 are shown, along with proposed trades 2140 and items listed for trade 2150. Finally, menu 2010 is used to select a “my products” screen 2300 showing products and total sales at 2310 or a transaction history or a shopping bag, as shown in FIG. 17.

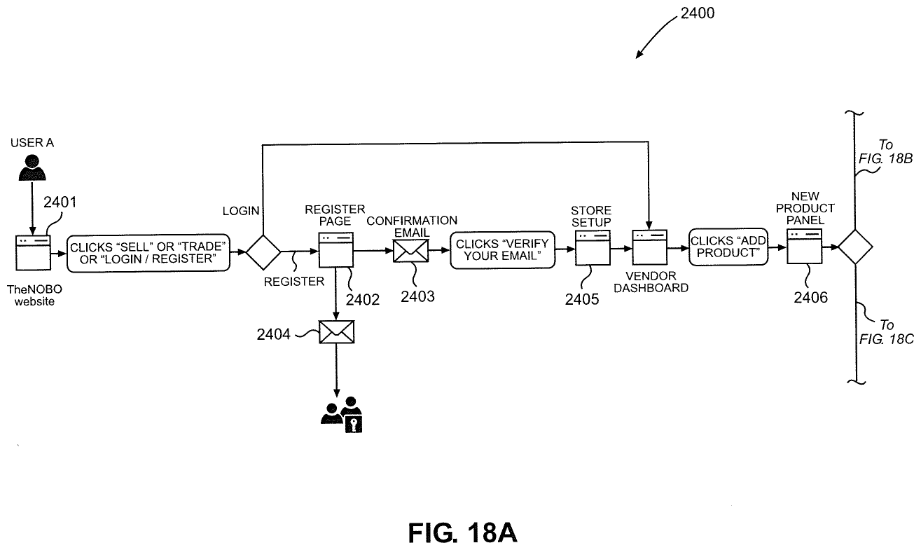

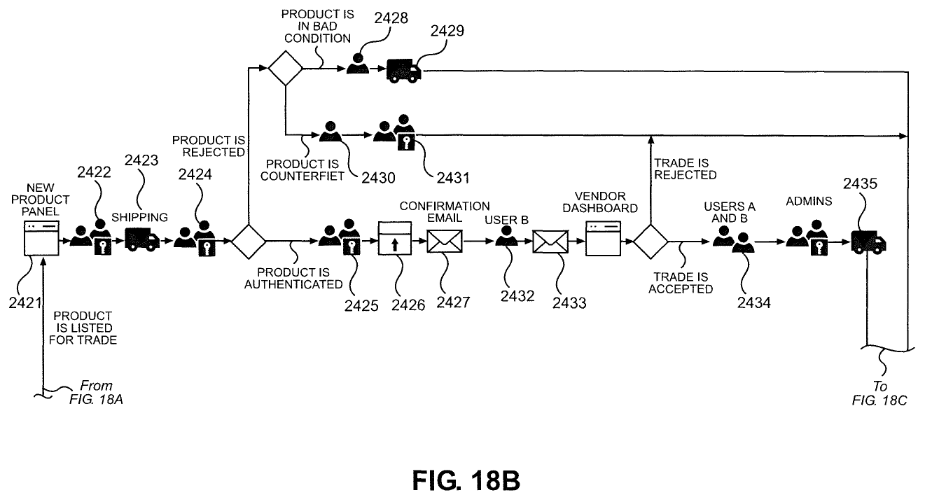

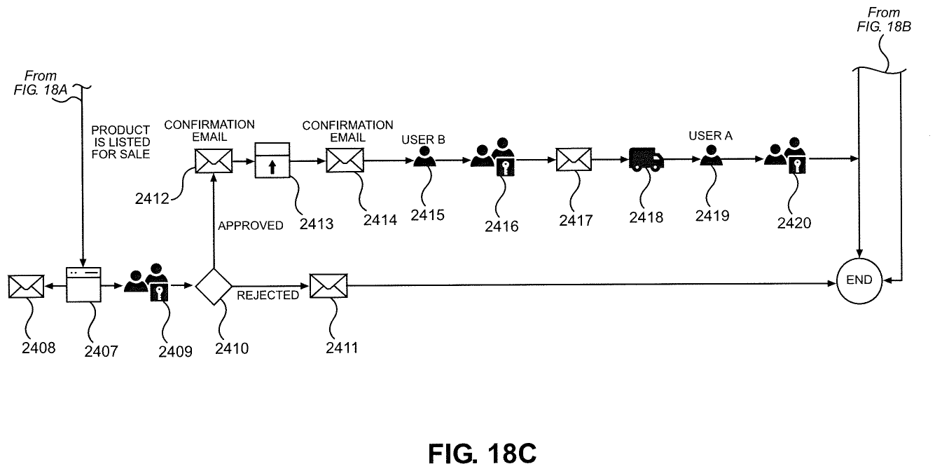

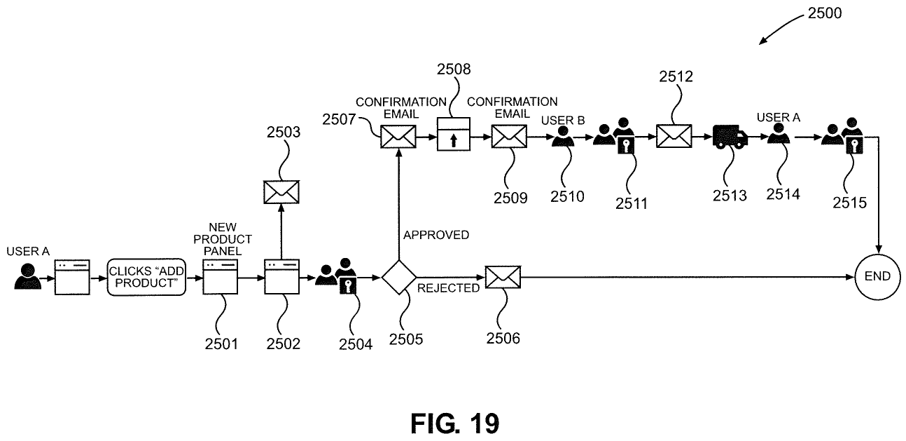

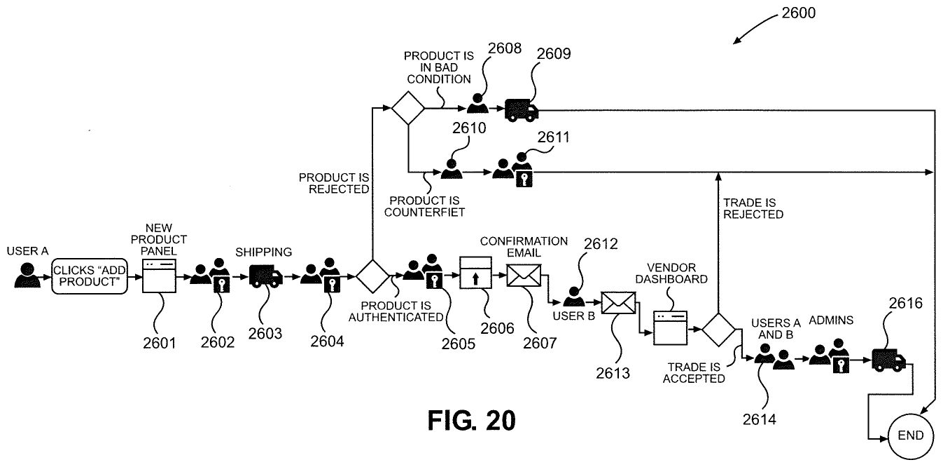

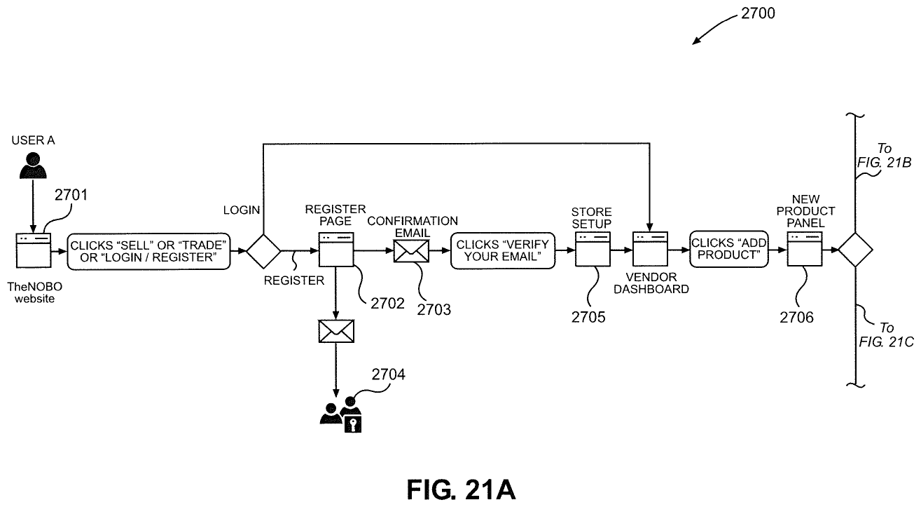

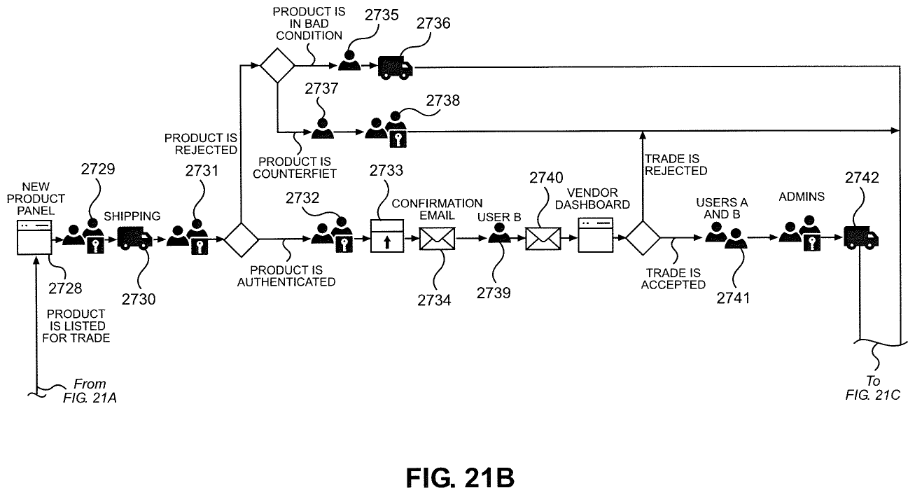

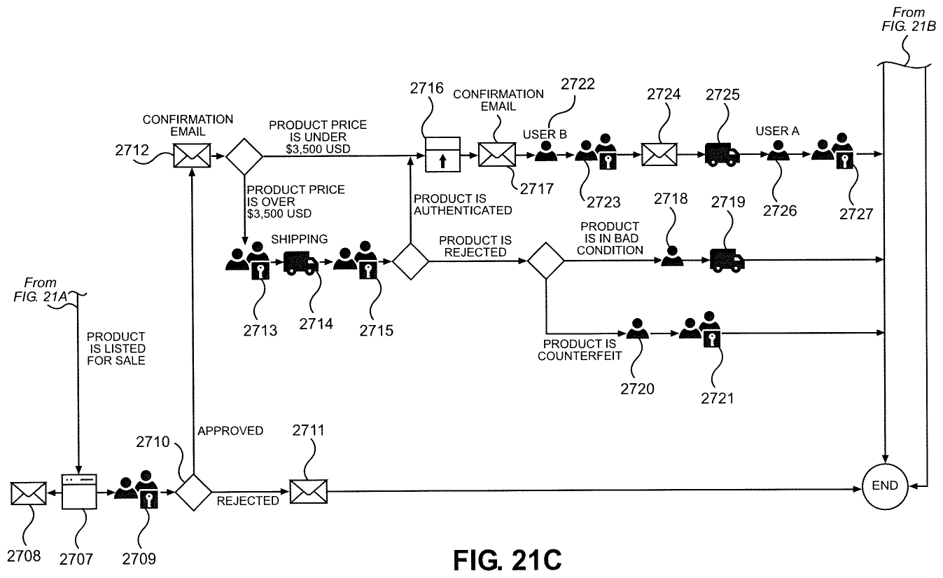

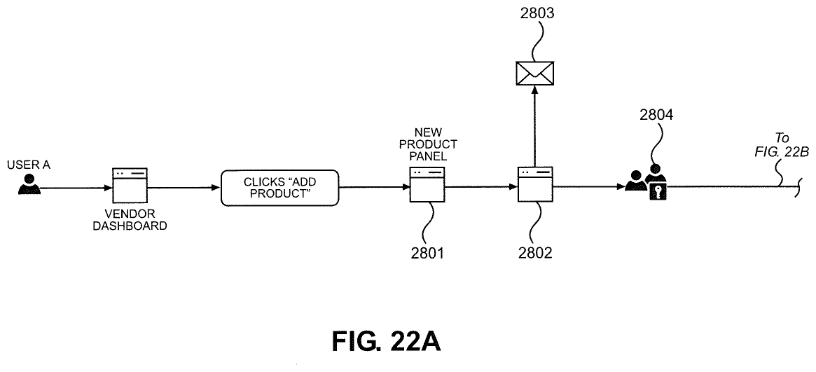

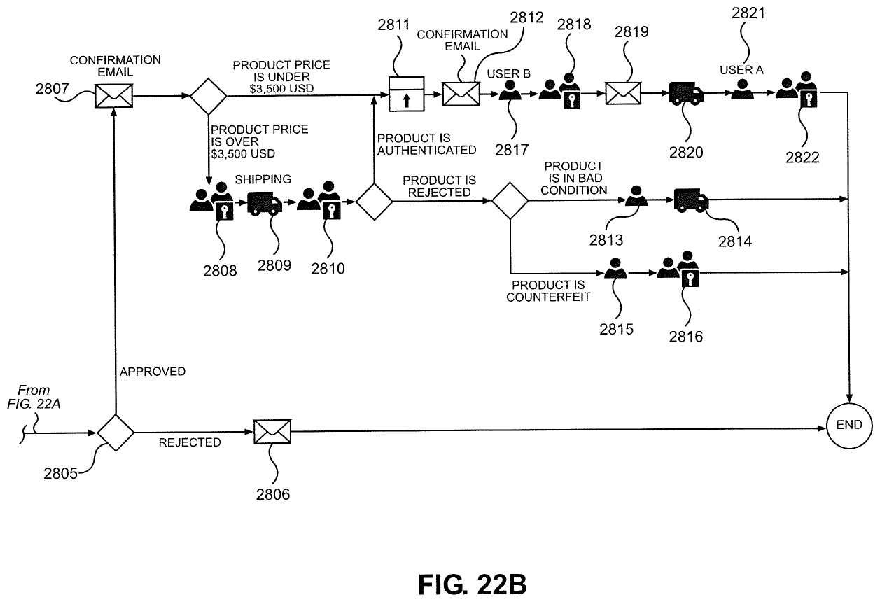

Turning now to FIGS. 18-22 there is shown several processes in accordance with additional preferred embodiments of the invention. FIGS. 18A-C show a flow chart of steps taken to place an item for sale or trade according to a second preferred embodiment of the invention. FIG. 19 is a flow chart for consignment transactions according to a third preferred embodiment of the invention. FIG. 20 is a flow chart adding authentication steps. FIGS. 21A-C show a flow chart for sale or trade of items with some items being particularly valuable and requiring authentication. FIG. 22A and 22B show a flow chart for selling items with some items being particularly valuable and requiring authentication. The processes are described with regard to a product but could also be used with an event, or, more generally, an item.

### Sales or Trade with Authentication

More specifically, in FIGS. 18A, 18B and 18C, there is shown a general flow of the process 2400 taken to place a product for sale or trade with the steps detailed below. First a user A arrives at the website at 2401. To sell or trade a product, user A is prompted to create an account. If a user A decides to create an account at 2402, user A registers a name, an email address, a phone number and a store name. The store name is the name of the online space used to sell products on the platform. Next, at 2403, user A gets an email with a password and a link to verify the email account. The platform administrators also get an email notice about the new registration by user A at 2404. User A finishes setting up the account by entering address and payment information at 2405 and then proceeds to a vendor dashboard. Alternatively, if user A already has an account, the registration process is skipped and user A simply completes a login process to access the vendor dashboard. When user A selects, “add product”, user A is taken to a new item panel at 2406 to list a product for sale or trade. If the product is to be listed for sale, user A adds a product at 2407 by selecting a category, brand or designer along with adding a price including, for example, a sales price or a retail price, and attributes such as size and color and others. See FIG. 18C. Additional attributes are also specified. User A then uploads photos of the product and a video showing the product for administrative review. User A will get an email notice at 2408 about the new product being under review. The platform administrators get an email notice about a new product pending approval at 2409. The platform administrators review the product for rejection or approval at 2410. At 2411 user A gets a notice about the product being rejected or a notice of approval at 2412.

Assuming the product is approved, the description of the product is then published at 2413. User A gets an email notice about the product being approved and published at step 2414. At 2415, when a user B buys user A's product, the platform administrators generate a shipping label for the product to allow for the product to be shipped from user A's address to user B's address at 2416. The shipping label is sent to user A via email at step 2417. Then, at step 2418, user A ships the product to user B. Next, user A requests to withdraw money earned by the product's sale at step 2419. Finally, the platform administrators issue a payment to user A at step 2420.

Going back to step 2406, if the product is listed for trade, the process moves to new product panel 2421 (best seen in FIG. 18B) where user A adds a product by selecting a category, brand or designer along with adding a price including, for example, a sales price or a retail price, and attributes such as size and color and others. At step 2422, the platform administrators will generate a shipping label for the product and send the shipping label to user A. At step 2423, user A ships the product to the platform and, at step 2424, the platform administrators receive the product and inspect the product to authenticate or reject it, preferably by having a facilitating agent determine if the item is authentic. If the product is authenticated, then, at step 2425, the platform administrators will take photos of the product and add the photos to the listing. Assuming the product is approved the product then the description of the product is published at 2426 and the product is available to be traded. User A will get an email notice at step 2427 about the product being approved and published. If the product is not approved and is in bad condition then, at 2428, user A has to pay for the shipping to get the product back. The platform administrators then ship the product back to user A at step 2429. However, if the product is determined to be counterfeit, at 2430, the platform administrators will destroy the product, as it is illegal to ship counterfeit products back to the seller (see step 2431).

With reference to step 2432, when a user B decides to trade one of their products to user A, then user B will make an offer. At step 2433, user A gets a notice via email and is prompted to go to the vendor dashboard and either accept or reject the trade. If the trade is accepted then, at step 2434, users A and B are prompted by a processor to pay for the transaction after which, at step 2435, the platform administrators will ship each user their corresponding product.

### Sales Transaction

Turning now to FIG. 19, there is shown a flow diagram representing a sale. User A goes to the vendor dashboard and clicks, “add product”, at which time user A will land on the new product panel at 2501 and makes a decision to list the product for sale. At 2502 user A adds a product by selecting a category, brand or designer along with adding a price including, for example, a sales price or a retail price, and attributes such as size and color and others. User A also uploads photos of the product or item and produces a video showing how the item works or provides other information for administrative review. At 2503, user A gets an email notice that the new product is now under review by the administrators. At step 2504, the platform administrators get an email notice about the new product pending approval. Then, at 2505, the platform administrators review the product and can approve or reject it. If it is rejected, then user A gets an email notice at 2506 that the product has been rejected. Alternatively, if the product is approved, user A gets an email notice at 2507 about their product being approved. The description of the product is then published and the product is available to be bought at 2508. At 2509 user A gets an email notice about the product being approved and published. Later on, if user B buys user A's product at 2510, then at 2511 the platform administrators generate a shipping label for the product from user A's address to user B's address. Next, at 2512, the shipping label is sent to user A via email and, at 2513, user A ships the product to user B. At 2514, user A requests to withdraw money earned from the product sale and finally, at 2515, the platform administrators issue payment.

### Trade with Authentication

Turning now to FIG. 20 there is shown a process for trading products. To start, user A clicks, “add product”, and is taken to the new product panel at 2601. User A adds a product by selecting a category, brand or designer along with adding a price including, for example, a sales price or a retail price, and attributes such as size and color and others. At step 2602, the platform administrators generate a shipping label for the product and send it to user A. At 2603, user A ships the product to the platform. At 2604, the platform administrators receive the product and inspect the product to authenticate or reject it. If the product is both authenticated and accepted, then the platform administrators take photos of the product and add the photos to the listing at step 2605. Assuming the product is approved then, at 2606, the description of the product is published and the product is available to be traded. At 2607, user A gets an email notice about the product being approved and published. At 2608, user A then pays for the shipping cost of sending the product to the platform for authentication and for shipping the product back, assuming that the product has not been approved, such as if the product is in bad condition. Alternatively, if the product is determined to be counterfeit, then user A has to pay for the shipping costs of sending the product to the platform but the product is not returned at step 2611, since the administrators will destroy the product, as it is illegal to ship counterfeit products back to user A. Later on, at step 2612, if user B decides to trade one of the products with user A, user B will then make an offer to user A. At step 2613, user A gets notice via email and is prompted to go to the vendor dashboard and either accept or reject the trade. If the trade is accepted, then users A and B are prompted by the processor to pay for the transaction at step 2614. After payment, platform administrators ship each user their corresponding product at step 2616 after which the process ends.

### Authentication of Valuable Item

In FIGS. 21A, 21B and 21C, there is shown a general flow of the process 2700 of steps taken to place a product for sale or trade as detailed below. First a user A arrives at the website at 2701. To sell or trade a product user A is prompted to create an account. If a user A decides to create an account at 2702, user A registers a name, an email address, a phone number and a store name. The store name is the name of the online space used to sell products on the platform. Next, at 2703, user A gets an email with a password and a link to verify the email account. The platform administrators also get an email notice about the new registration by user A at 2704. User A finishes setting up the account by entering address and payment information at 2705 and proceeds to a vendor dashboard. Alternatively, if user A already has an account, the registration process is skipped and user A simply completes a login process to access the vendor dashboard. When user A selects, “add product”, user A is taken to a new item panel at 2706 to list a product for sale or trade. If the product is to be listed for sale, user A adds a product at 2707 selecting a category, brand or designer along with adding a price including, for example, a sales price or a retail price, and attributes such as size and color and others. See FIG. 21C. User A uploads photos of the product and a video showing the product for administrative review. User A gets an email notice at 2708 about the new product being under review. The platform administrators get an email notice about a new product pending approval at 2709. The platform administrators review the product for rejection or approval at 2710. At 2711 user A gets a notice about the product being rejected or a notice of approval at 2712.

If the product is determined to be a high value item worth over a set amount, for example $3500, then the platform administrators will generate a shipping label for the product at 2713 and send it to user A. At 2714, user A ships the product to the platform and pays for return shipping. The platform administrators receive the product and inspect it at 2715 preferably by having a facilitating agent determine if the item is authentic.

If the product is authentic, the description of the product is published. User A gets an email notice about the product being approved and published at step 2717. After inspecting the product at step 2715, the product may be authenticated and the process again proceeds to step 2716. Otherwise, the product is either judged to be a bad product, at step 2718, and is shipped back to user A at 2719 or is judged to be counterfeit, at step 2720, and is destroyed at step 2721. At 2722, when user B buys user A's product and the platform administrators generate a shipping label for the product to allow for the product to be shipped from user A's address to user B's address at 2723. The shipping label is sent to user A via email at step 2724. At step 2725, user A ships the product to user B. Next, user A requests to withdraw money earned by the product's sale at step 2726. Finally, the platform administrators issue a payment to user A at step 2727.

Going back to step 2706, if the product is listed for trade, the process moves to new product panel 2728 (best seen in FIG. 21B) where user A adds a product by selecting a category, brand or designer along with adding a price including, for example, a sales price or a retail price, and attributes such as size and color and others. At step 2729, the platform administrators will generate a shipping label for the product to be sent to the platform and send the shipping label to user A. At step 2730, user A ships the product to the platform and, at step 2731, the platform administrators receive the product and inspect product to authenticate or reject it, preferably by having a facilitating agent determine if the item is authentic. If the product is authenticated, then at step 2732, the platform administrators will take photos of the product and add the photos to the listing. Assuming the product is approved, the description of the product is then published at 2733 and the product is available to be traded. User A gets an email notice at step 2734 about the product being approved and published. If the product is not approved and is in bad condition, then at 2735, user A has to pay for the shipping to get the product back. The platform administrators ship the product back to user A, at step 2736. However, if the product is determined to be counterfeit, then, at 2737, the platform administrators will destroy the product, as it is illegal to ship counterfeit products back to the seller (see step 2738).

With reference to step 2739, when a user B decides to trade one of their products to user A, user B will make an offer. At step 2740, user A gets a notice via email and is prompted to go to the vendor dashboard and either accept or reject the trade. If the trade is accepted, then, at step 2741, users A and B are prompted to pay for the transaction after which, at step 2742, the platform administrators will ship each user their corresponding product.

### Sales with Authentication of Valuable Item

Turning now to FIGS. 22A and 22B, there is shown a flow diagram representing a sale. User A goes to the vendor dashboard and clicks, “add product”, at which time user A will land on the new product panel at 2801 and makes a decision to list the product for sale. At 2802, user A adds a product by selecting a category, brand or designer along with adding a price including, for example, a sales price or a retail price, and attributes such as size and color and others. User A also uploads photos of the product or item and produces a video showing how the item works or provides other information for administrative review. At 2803, user A gets an email notice that the new product is now under review by the administrators. At step 2804, the platform administrators get an email notice about the new product pending approval. At 2805, the platform administrators review the product and can approve or reject it. If it is rejected, then user A gets an email notice at 2806 that the product has been rejected. Alternatively, if the product is approved or is under a certain amount, for example $3500, then at 2811, user A gets an email notice at 2812 about the product being approved. If the product is worth more than a certain amount, for example $3500, then the product will undergo secondary screening. The platform administrators will generate a shipping label at 2808 so that user A can ship the product to the platform at 2809. The administrators either authenticate the product, at 2810, and process goes to step 2811 or the product is judged to be either in bad condition at step 2813 and is shipped back to user A at step 2814, or the product is judged to be counterfeit at step 2815 and is destroyed at step 2816.

Turning back to step 2811, the process moves to 2817. When user B buys user A's product, at 2818, the platform administrators generate a shipping label for the product from user A's address to user B's address. Next, at 2819, the shipping label is sent to user A via email and, at 2820, user A ships the product to user B. At 2821, user A requests to withdraw money earned from the product sale and finally, at 2822, the platform administrators issue payment.

Based on the above, it should be clear that the present invention provides users the opportunity to trade, sell or buy previously owned luxury items while avoiding traditional consignment fees. The invention also provides the opportunity to conserve value through trading and allows new luxury buyers, who may remain anonymous, to enter the retail luxury market.

Although described with reference to preferred embodiments, it should be readily understood that various changes or modifications could be made to the invention without departing from the spirit thereof. Thus, although specific embodiments have been illustrated and described herein, any arrangement calculated to achieve the same purpose may be substituted for the specific embodiments shown. For example, in addition to offering luxury items or experiences, financing options could also be offered. Also, the term “trade” is used to describe both a trade of one item for another item in a bartering transaction or a trade of one item for money in a sales or consignment transaction. This disclosure is intended to cover any and all adaptations or variations of various embodiments. Combinations of the above embodiments, and other embodiments not specifically described herein, will be apparent to those of skill in the art upon reviewing the above description. In general, the invention is only intended to be limited by the scope of the following claims.

1. A method of facilitating trading products, goods, experiences or other items using an online platform having a server, the method comprising:
storing, in a database of on a non-transitory computer-readable medium, information of an item offered by a first user;
determining if the item is a high value item over a certain limit; and
when the item is determined to be a high value item:
evaluating the high value item by a facilitating agent to determine if the item is an authentic high value item;
sending, through an electronic network for trade purposes, a description of the authentic high value item from the database if when the item is deemed authentic;
receiving, through the electronic network, an inquiry for the item from a second user including receiving an offer for a reciprocal item from the second user; and
processing a trade of the item only when the value of the high value item is within a predetermined value bandwidth of the reciprocal item, with the predetermined value bandwidth being up to 30%.

2. (canceled)

3. The method according to claim 1, further comprising sending the reciprocal item to the facilitating agent for evaluation of the reciprocal item to determine if the reciprocal item is authentic.

4. The method according to claim 3, wherein evaluation of the reciprocal item includes:
taking pictures of the reciprocal item; and
storing the pictures and collecting other information about the reciprocal item.

5. The method according to claim 4, wherein processing the trade constitutes stopping the trade if the reciprocal item is not authentic.

6. The method according to claim 1, wherein the item is a stay in a hotel, tickets to a concert, a stay in a furnished residence, or a travel package.

7. The method according to claim 1, wherein evaluation of the item includes:
taking pictures of the item; and
storing the pictures and collecting other information about the item.

8. The method according to claim 1, further comprising completing the trade of the item for the reciprocal item, if both users agree.

9. The method according to claim 8, further comprising automatically taking a transaction fee through the online platform.

10. The method according to claim 8, wherein completing the trade of the item for the reciprocal item includes shipping the item and shipping the reciprocal item.

11. The method according to claim 1, wherein evaluation of the item includes:
taking pictures of the item; and
storing the pictures and collecting other information about the item.

12. The method according to claim 1, further comprising completing the trade as a sale of the item for money, if both users agree.

13. The method according to claim 12, further comprising automatically taking a transaction fee through the online platform.

14. The method according to claim 12, wherein processing a sale of the item includes shipping the item.

15. An online trading platform for facilitating trading products, goods, experiences or other items that connects a first user having a computer via a communication network to a second user having another computer, the online trading platform comprising:
a server having a database for listing an item offered by a first user stored on a non-transitory computer-readable medium;
a communication system configured to:
send, through an electronic network for trade purposes, a description of the item from the database only if the item is determined to be a high value item over a certain limit and is evaluated as authentic; and
receive, through the electronic network, an inquiry for the item from a second user; and
a processor configured to process a trade of the item if the item is authentic and the first and second users agree to the trade, wherein the processor is configured to process the trade for a reciprocal item only when the reciprocal item has a value within a predetermined value bandwidth of the item offer by the first user, with the predetermined value bandwidth being up to 30%.

16. The online trading platform of claim 15, wherein the processor is configured to process the trade of the item for money.

17.-18. (canceled)

19. The online trading platform of claim 15, wherein the processor is further configured to process the trade only if the reciprocal item has been evaluated as authentic.

20. The online trading platform of claim 19, wherein the processor is configured to automatically take a transaction fee for the trade.

21. The online trading platform of claim 15, wherein the predetermined value bandwidth is up to 10%.

22. The method according to claim 1, wherein the predetermined value bandwidth is up to 10%.
